(19) United States
(12) Patent Application Publication
(10) Pub. No.: US 2012/0200169 A1
(43) Pub. Date: Aug. 9, 2012

(54) WIRELESS POWER FEEDER AND WIRELESS POWER TRANSMISSION SYSTEM

(76) Inventor: Takashi URANO, Tokyo (JP)

(21) Appl. No.: 13/369,090

(22) Filed: Feb. 8, 2012

Related U.S. Application Data
(60) Provisional application No. 61/440,636, filed on Feb. 8, 2011.

(51) Int. Cl. H02J 17/00

(52) U.S. Cl. 307/104

(57) ABSTRACT

Power is transmitted based on magnetic resonance from a feeding coil L2 to a receiving coil L3. An adjustment circuit 104 of a wireless power receiver 118 is supplied with a first AC power received by the receiving coil L3. An adjustment circuit 104 includes a DC circuit 106 and an AC circuit 150. The DC circuit 106 converts the first AC power into DC power. The AC circuit 150 converts the DC power into a second AC power. The adjustment circuit 104 outputs the DC power and second AC power simultaneously or selectively through separate channels.

### BACKGROUND OF THE INVENTION

1. Field of the Invention

The present invention relates to a wireless power receiver for receiving power fed by wireless and a wireless power transmission system.

2. Description of Related Art

A wireless power feeding technique of feeding power without a power cord is now attracting attention. The current wireless power feeding technique is roughly divided into three: (A) type utilizing electromagnetic induction (for short range); (B) type utilizing radio wave (for long range); and (C) type utilizing resonance phenomenon of magnetic field (for intermediate range).

The type (A) utilizing electromagnetic induction has generally been employed in familiar home appliances such as an electric shaver; however, it can be effective only in a short range of several centimeters. The type (B) utilizing radio wave is available in a long range; however, it cannot feed big electric power. The type (C) utilizing resonance phenomenon is a comparatively new technique and is of particular interest because of its high power transmission efficiency even in an intermediate range of about several meters. For example, a plan is being studied in which a receiving coil is buried in a lower portion of an EV (Electric Vehicle) so as to feed power from a feeding coil in the ground in a non-contact manner. The wireless configuration allows a completely insulated system to be achieved, which is especially effective for power feeding in the rain. Hereinafter, the type (C) is referred to as “magnetic field resonance type”.

The magnetic field resonance type is based on a theory published by Massachusetts Institute of Technology in 2006 (U.S. Pat. Appln. Publication No. 2008/0278264). In U.S. Pat. Appln. Publication No. 2008/0278264, four coils are prepared. The four coils are referred to as “exciting coil”, “feeding coil”, “receiving coil”, and “loading coil” in the order starting from the feeding side. The exciting coil and feeding coil closely face each other for electromagnetic coupling. Similarly, the receiving coil and loading coil closely face each other for electromagnetic coupling. The distance (intermediate distance) between the feeding coil and receiving coil is larger than the distance between the exciting coil and feeding coil and distance between the receiving coil and loading coil. This system aims to feed power from the feeding coil to receiving coil.

When AC power is fed to the exciting coil, current also flows in the feeding coil according to the principle of electromagnetic induction. When the feeding coil generates a magnetic field to cause the feeding coil and receiving coil to magnetically resonate, large current flows in the receiving coil.

At this time, current also flows in the loading coil according to the principle of electromagnetic induction, and power is taken out from a load connected in series to the loading coil. By utilizing the magnetic field resonance phenomenon, high power transmission efficiency can be achieved even if the feeding coil and receiving coil are largely spaced from each other.

The present inventor considers that it is necessary to provide a mechanism for generating a desired output voltage waveform at a power receiving side regardless of a drive frequency at a power feeding side in order to increase availability of wireless power feeding. For example, in order to generate an output voltage of 50 Hz or 60 Hz which is a commercial frequency, it is more rational to adjust the frequency of received power to the commercial frequency band than to adjust the drive frequency of the feeding side to the commercial frequency band. This is because it is desirable to feed power at the drive frequency close to a resonance frequency in terms of power transmission efficiency. Further, in the case where power needs to be fed from one wireless power feeder to a plurality of wireless power receivers, it is more rational to individually adjust the output voltage waveforms at the receiving sides.

In recent years, a distributed DC power supply such as a solar cell or a fuel cell is spreading. Further, there are increased number of home appliances that operate on DC power, not on AC power. It is necessary for the wireless power feeding to cope with such a DC/AC-mixed environment.

A main object of the present invention is to achieve a magnetic field coupling type wireless power transmission system capable of coping with the DC/AC-mixed environment.

### SUMMARY

A wireless power receiver according to the present invention receives, at a receiving coil, AC power fed from a feeding coil by wireless based on a magnetic field coupling between the feeding coil and a receiving coil. The wireless power receiver includes: the receiving coil; and an adjustment circuit that is fed a first AC power received by the receiving coil. The adjustment circuit includes: a first conversion circuit that converts the first AC power into DC power; and a second conversion circuit that converts the DC power into a second AC power of a predetermined frequency. The adjustment circuit outputs the DC power and second AC power through separate channels.

With the above configuration, power can be fed to an AC power driven electronic device and a DC power driven electronic device simultaneously or selectively by a single wireless power receiver.

The wireless power receiver may further include a loading coil magnetically coupled to the receiving coil to receive the first AC power from the receiving coil. The adjustment circuit may receive the first AC power through the loading coil.

The DC power output from the first conversion circuit may be supplied to a DC connector installed in a wall surface of a house, and the second AC power output from the second conversion circuit may be supplied to an AC connector installed in the wall surface of the house.

The second conversion circuit may further include: a reference signal generation circuit that generates a reference signal at a reference frequency; and a control signal generation circuit that receives an input signal including a frequency component lower than the reference frequency and generates a control signal representing a magnitude relation between a signal level of the reference signal and that of the input signal. The second conversion circuit may generate the second AC power from the DC power according to the control signal.

The control signal generation circuit may change a duty ratio of the control signal according to the magnitude relation between the signal level of the reference signal and that of the input signal.

A wireless power transmission system according to the present invention includes: the above-described wireless power receiver; the feeding coil; and a power transmission control circuit that supplies the feeding coil with AC power to make the feeding coil feed the AC power to the receiving coil.

The feeding coil may be installed outdoors, and the receiving coil may be installed indoors.

Another wireless power transmission system according to the present invention is a system for feeding power by wireless from a feeding coil to a receiving coil based on a magnetic field coupling between the feeding coil and receiving coil. The system includes: the feeding coil; a plurality of the receiving coils; a power transmission control circuit that supplies AC power to the feeding coil to make the feeding coil feed the AC power to the receiving coils; a first conversion circuit that converts a first AC power received by each receiving coil into DC power; and a second conversion circuit that converts the DC power into a second AC power of a predetermined frequency. The receiving coils include a first receiving coil that outputs the DC power through the first conversion circuit and a second receiving coil that outputs the second AC power through both the first and second conversion circuits.

It is to be noted that any arbitrary combination of the above-described structural components and expressions changed between a method, an apparatus, a system, etc. are all effective as and encompassed by the present embodiments.

According to the present invention, it is possible to achieve a magnetic field coupling type wireless power transmission system capable of coping with the DC/AC-mixed environment.

### BRIEF DESCRIPTION OF THE DRAWINGS

FIG. 1 is a view illustrating an operation principle of a wireless power transmission system in a first embodiment;

FIG. 2 is a schematic diagram of the wireless power transmission system in the first embodiment;

FIG. 3 is a system configuration diagram of the wireless power transmission system in the first embodiment;

FIG. 4 is a time chart illustrating a relationship between an input signal and a reference signal;

FIG. 5 is a time chart illustrating a relationship among the input signal, reference signal, and a control signal in a high range;

FIG. 6 is a time chart illustrating a relationship among the input signal, reference signal, and control signal in a middle range;

FIG. 7 is a time chart illustrating a relationship among the input signal, reference signal, and control signal in a low range;

FIG. 8 is a time chart illustrating a relationship between the input signal and an output voltage;

FIG. 9 is a conceptual view illustrating a case where the wireless power transmission system is applied to a standard house;

FIG. 10 is a schematic view of the wireless power transmission system in a second embodiment;

FIG. 11 is an application example of the wireless power transmission system in a third embodiment;

FIG. 12 is a view illustrating an operation principle of the wireless power transmission system in a fourth embodiment;

FIG. 13 is a system configuration diagram of the wireless power transmission system in the fourth embodiment;

FIG. 14 is a view illustrating a wireless-enabled drum-type washing machine;

FIG. 15 is a view illustrating a television and a television table which are wireless-enabled;

FIG. 16 is a view illustrating a wireless-enabled fuel cell; and

FIG. 17 is a view illustrating an application example of the wireless power transmission system including the fuel cell.

### DETAILED DESCRIPTION OF THE EMBODIMENTS

Preferred embodiments of the present invention will be described below with reference to the accompanying drawings.

### First Embodiment

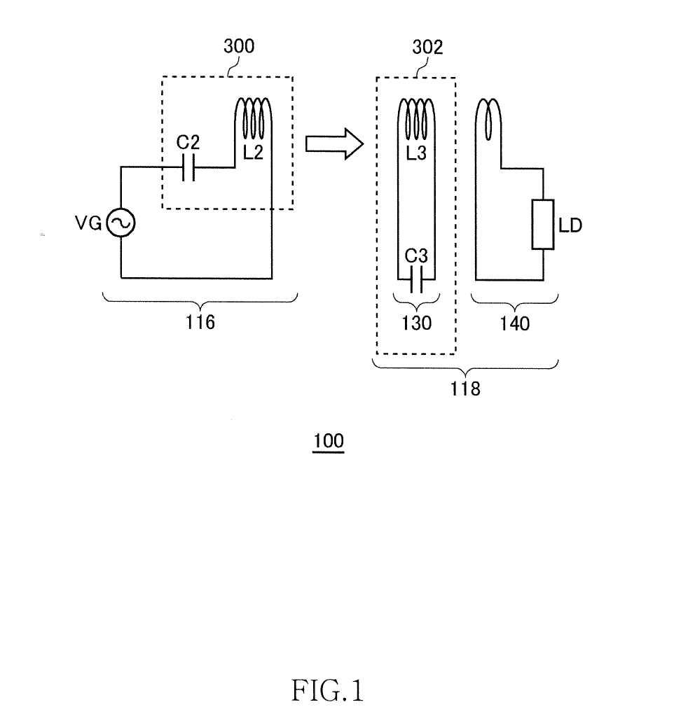

FIG. 1 is a view illustrating operation principle of a wireless power transmission system 100 according to a first embodiment. The wireless power transmission system 100 of the first embodiment includes a wireless power feeder 116 and a wireless power receiver 118. The wireless power feeder 116 includes a power feeding LC resonance circuit 300. The wireless power receiver 118 includes a receiving coil circuit 130 and a loading circuit 140. A power receiving LC resonance circuit 302 is formed by the receiving coil circuit 130.

The power feeding LC resonance circuit 300 includes a capacitor C2 and a feeding coil L2. The power receiving LC resonance circuit 302 includes a capacitor C3 and a receiving coil L3. The values of the capacitor C2, power feeding coil L2, capacitor C3, and power receiving coil L3 are set such that the resonance frequencies of the power feeding LC resonance circuit 300 and power receiving LC resonance circuit 302 coincide with each other in a state where the power feeding coil L2 and power receiving coil L3 are disposed away from each other far enough to ignore the magnetic field coupling therebetween. This common resonance frequency is assumed to be fr0.

In a state where the power feeding coil L2 and power receiving coil L3 are brought close to each other in such a degree that they can be magnetic-field-coupled to each other, a new resonance circuit is formed by the power feeding LC resonance circuit 300, power receiving LC resonance circuit 302, and mutual inductance generated between them. The new resonance circuit has two resonance frequencies fr1 and fr2 (fr1<fr0<fr2) due to the influence of the mutual inductance. When the wireless power feeder 116 supplies AC power from a power feeding source VG to the power feeding LC resonance circuit 300 at the resonance frequency fr1, the power feeding LC resonance circuit 300 constituting a part of the new resonance circuit resonates at a resonance point 1 (resonance frequency fr1). When the power feeding LC resonance circuit 300 resonates, the power feeding coil L2 generates an AC magnetic field of the resonance frequency fr1. The power receiving LC resonance circuit 302 constituting a part of the new resonance circuit also resonates by receiving the AC magnetic field. When the power feeding LC resonance circuit 300 and power receiving LC resonance circuit 302 resonate at the same resonance frequency fr1, wireless power feeding from the power feeding coil L2 to power receiving coil L3 is performed with the maximum power transmission efficiency. Received power is taken from a load LD of the wireless power receiver 118 as output power. Note that the new resonance circuit can resonate not only at the resonance point 1 (resonance frequency fr1) but also at a resonance point 2 (resonance frequency fr2).

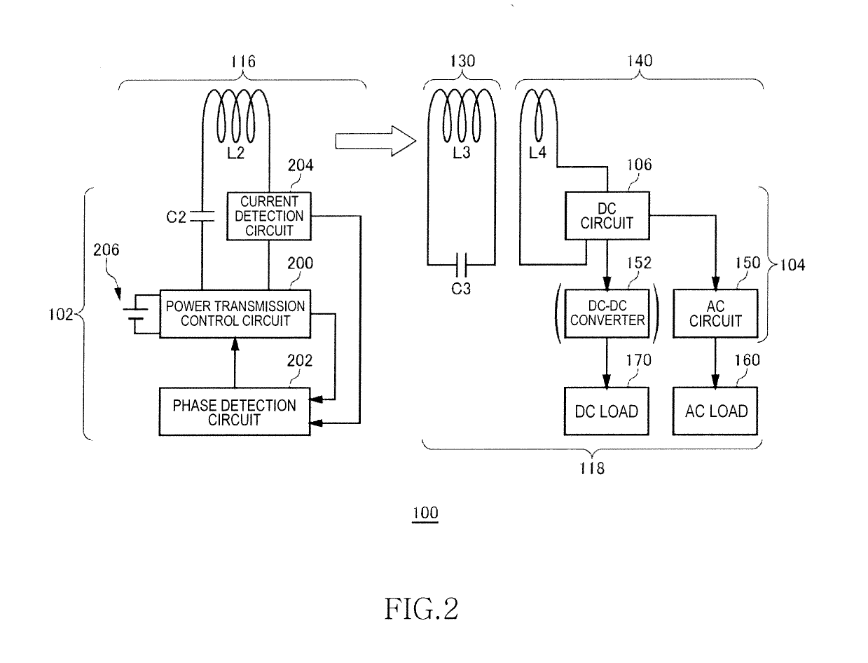

FIG. 2 is a schematic diagram of the wireless power transmission system 100 in the first embodiment. A power transmission control circuit 200 includes a VCO (Voltage Controlled Oscillator) and generates AC current of a drive frequency fo from a DC power supply 206. A current detection circuit 204 measures a phase of the AC current flowing in the feeding coil L2. A phase detection circuit 202 compares a phase of voltage Vo generated by the power transmission control circuit 200 and current phase detected by the current detection circuit 204. When the drive frequency fo coincides with the resonance frequency fr1, the current phase and voltage phase also coincide with each other. The power transmission control circuit 200 detects a deviation (phase difference) between the current phase and voltage phase to thereby detect a deviation between the drive frequency fo and resonance frequency fr1 and adjusts the drive frequency fo so as to eliminate the frequency deviation. With the above configuration, the wireless power feeder 116 makes the drive frequency fo to track the resonance frequency fr1. In this manner, AC power of the resonance frequency fr1 is fed by wireless from the feeding coil L2 to receiving coil L3.

The wireless power receiver 118 includes a receiving coil circuit 130 and a loading circuit 140. In the receiving coil circuit 130, the power receiving LC resonance circuit 302 is formed by the receiving coil L3 and capacitor C3. AC power (first AC power) received by the receiving coil circuit 130 is further supplied to the loading circuit 140.

A loading circuit 140 is connected to a DC circuit 106 (first conversion circuit). Received AC power is rectified/smoothed by the DC circuit 106 to be DC power. The DC power output from the DC circuit 106 is supplied without modification to a load (hereinafter, referred to as “DC load 170”) such as a DC power driven home appliance. The level of DC voltage may be adjusted using a DC-DC converter 152. Some of the DC power output from the DC circuit 106 is converted into AC power (second AC power) of a desired frequency by an AC circuit 150 (second conversion circuit). That is, the AC circuit 150 is a kind of DC-AC converter. The AC power output from the AC circuit 150 is supplied to a load (hereinafter, referred to as “AC load 160”) of an AC power driven home appliance.

The DC circuit 106 and AC circuit 150 constitutes an adjustment circuit 104 which allows the loading circuit 140 to simultaneously or selectively output the DC power and AC power through separate channels. In other words, power can be fed to the AC load 160 and DC load 170 simultaneously or selectively by the single loading circuit 140. For example, this configuration can be achieved by providing a switch in the DC circuit 106 and specifying both or one of output channels to the DC load 170 and AC load 160 as output destinations. Alternatively, the DC power and AC power may be selectively output depending on which one of the DC load 170 or AC load 160 is connected to its output channel. A frequency of the AC power output from the AC circuit 150 can be adjusted to an arbitrary value according to the AC load 160.

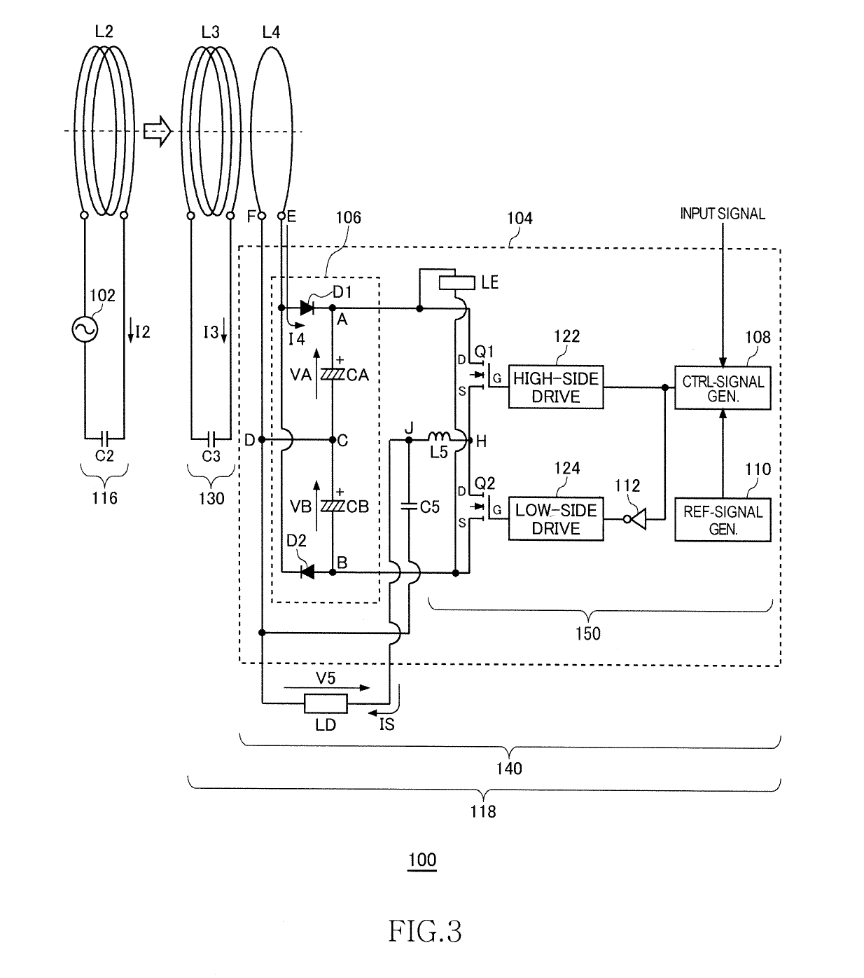

FIG. 3 is a system configuration view of the wireless power transmission system 100. The wireless power transmission system 100 includes a feeding-side wireless power feeder 116 and a receiving-side wireless power receiver 118. The wireless power feeder 116 includes an AC power supply 102, a capacitor C2, and a feeding coil L2. The wireless power feeder 116 illustrated in FIG. 3 has a simple configuration in which the wireless power feeder 116 directly drives the feeding coil L2 without intervention of an exciting coil. The wireless power receiver 118 includes a receiving coil circuit 130 and a loading circuit 140.

A distance (hereinafter, referred to as “inter-coil distance”) of about 0.2 m to 1.0 m is provided between a power feeding coil L2 of the wireless power feeder 116 and a power receiving coil L3 of the receiving coil circuit 130. The wireless power transmission system 100 mainly aims to feed power from the power feeding coil L2 to power receiving coil L3 by wireless. In the first embodiment, a description will be made assuming that resonance frequency fr1 is 100 kHz. The wireless power transmission system of the present embodiment may be made to operate in a high-frequency band like ISM (Industry-Science-Medical) frequency band. A low frequency band is advantageous over a high frequency band in reduction of cost of a switching transistor (to be described later) and reduction of switching loss. In addition, the low frequency band is less constrained by Radio Act.

The number of windings of the feeding coil L2 is 7, diameter of a conductive wire thereof is 5 mm, and shape of the feeding coil L2 itself is a square of 280 mm×280 mm. The values of the feeding coil L2 and capacitor C2 are set such that the resonance frequency fr1 is 100 kHz. In FIG. 3, the feeding coil L2 is represented by a circle for descriptive purpose. Other coils are also represented by circles for the same reason. All the coils illustrated in FIG. 3 are made of copper. AC current I2 flows in the wireless power feeder 116.

The receiving coil circuit 130 is a circuit in which a power receiving coil L3 and a capacitor C3 are connected in series. The power feeding coil L2 and power receiving coil L3 face each other. The number of windings of the power receiving coil L3 is 7, diameter of a conductive wire is 5 mm, and shape of the power receiving coil L3 itself is a square of 280 mm×280 mm. The values of the power receiving coil L3 and capacitor C3 are set such that the resonance frequency fr1 of the receiving coil circuit 130 is also 100 kHz. Thus, the power feeding coil L2 and power receiving coil L3 need not have the same shape. When the power feeding coil L2 generates a magnetic field at the resonance frequency fr1=100 kHz, the power feeding coil L2 and power receiving coil L3 magnetically resonate, causing large current I3 to flow in the receiving coil circuit 130.

The loading circuit 140 has a configuration in which a loading coil L4 is connected to a load LD through an adjustment circuit 104. The receiving coil L3 and loading coil L4 face each other. In the present embodiment, the coil plane of the receiving coil L3 and that of the loading coil L4 are substantially the same. Thus, the receiving coil L3 and loading coil L4 are electromagnetically strongly coupled to each other. The number of windings of the loading coil L4 is 1, diameter of a conductive wire thereof is 5 mm, and shape of the loading coil L4 itself is a square of 300 mm×300 mm. When the current I3 flows in the receiving coil L3, an electromotive force occurs in the loading circuit 140 to cause AC current I4 to flow in the loading circuit 140. The AC current I4 is rectified by the adjustment circuit 104, and current IS flows in the load LD. The details of the adjustment circuit 104 will be described later.

The AC power fed from the feeding coil L2 of the wireless power feeder 116 is received by the receiving coil L3 of the wireless power receiver 118 and, finally, an output voltage V5 is taken from the load LD.

If the load LD is connected in series to the receiving coil circuit 130, the Q-value of the receiving coil circuit 130 is degraded. Therefore, the receiving coil circuit 130 for power reception and loading circuit 140 for power extraction are separated from each other. In order to enhance the power transmission efficiency, the center lines of the power feeding coil L2, power receiving coil L3, and loading coil L4 are preferably made to coincide with one another.

The adjustment circuit 104 includes a DC circuit 106. Capacitors CA and CB included in the DC circuit 106 are each charged by received power (AC power) and function as a DC voltage source. The capacitor CA is provided between points A and C of FIG. 3, and capacitor CB is provided between points C and B. It is assumed here that the voltage (voltage between points A and C) of the capacitor CA is VA, voltage (voltage between points C and B) of the capacitor CB is VB. Hereinafter, VA+VB (voltage between points A and B) is referred to as “DC power supply voltage”.

The current I4 flowing in the loading coil L4 is AC current and therefore it flows alternately in a first path and a second path. The first path starts from an end point E of the loading coil L4, passes through the diode D1, point A, capacitor CA, point C, and point D in this order, and returns to an end point F of the loading coil L4. The second path, which is a reverse path of the first path, starts from the end point F of the loading coil L4, passes through the point D, point C, capacitor CB, point B, and diode D2 in this order, and returns to the end point E of the loading coil L4. As a result, the capacitors CA and CB are each charged by received power.

The point A is connected to the drain of a switching transistor Q1, and the point B is connected to the source of a switching transistor Q2. The source of the switching transistor Q1 and drain of the switching transistor Q2 are connected at a point H. The point H is connected to the point D through an inductor L5, a point J, and a capacitor C5. The point J at which the inductor L5 and capacitor C5 are connected is connected to one end of the load LD, and the other end of the load LD is connected to the point D.

The switching transistors Q1 and Q2 are enhancement type MOSFET (Metal Oxide Semiconductor Field effect transistor) having the same characteristics but may be other transistors such as a bipolar transistor. Further, other switches such as a relay switch may be used in place of the transistor.

When the switching transistor Q1 is turned conductive (ON), the switching transistor Q2 is turned non-conductive (OFF). A concrete control method will be described later. A main current path (hereinafter, referred to as “high current path”) at this time starts from the positive electrode of the capacitor CA, passes through the point A, switching transistor Q1, point H, inductor L5, point J, load LD, and point D in this order, and returns to the negative electrode of the capacitor CA. The switching transistor Q1 functions as a switch for controlling conduction/non-conduction of the high current path.

When the switching transistor Q2 is turned conductive (ON), the switching transistor Q1 is turned non-conductive (OFF). A main current path (hereinafter, referred to as “low current path”) at this time starts from the positive electrode of the capacitor CB, passes through the point C, point D, load LD, point J, inductor L5, switching transistor Q2, and point B in this order, and returns to the negative electrode of the capacitor CB. The switching transistor Q2 functions as a switch for controlling conduction/non-conduction of the low current path.

The current IS flowing in the load LD is AC current. The direction of the current IS flowing in the high current path is assumed to be the positive direction, and direction of the current IS flowing in the low current path is assumed to be the negative direction.

The adjustment circuit 104 further includes a control signal generation circuit 108, a reference signal generation circuit 110, an inverter 112, a high-side drive 122, and a low-side drive 124. An input signal is supplied to the control signal generation circuit 108. The input signal may assume arbitrary voltage waveform. The adjustment circuit 104 uses the capacitors CA and CB as DC voltage sources and supplies the output voltage V5 obtained by amplifying the input signal to the load LD. It is assumed in the present embodiment that in order to generate 50 Hz sine-wave output voltage V5 which is a commercial frequency, a 50 Hz sine-wave input signal is supplied to the control signal generation circuit 108. Further, it is assumed that the DC power source voltage is set to 141 (V) or more in order to make the effective value of the output voltage V5 be 100 (V).

The reference signal generation circuit 110 generates a reference signal having a higher frequency (hereinafter, referred to as “reference frequency”) than the frequency (hereinafter, referred to as “signal frequency”) of the input signal. The reference signal used in the present embodiment is a 20 kHz triangle-wave AC signal.

The control signal generation circuit 108 generates a control signal representing a magnitude relation between the input signal and reference signal. The control signal is a rectangular wave AC signal whose duty ratio changes depending on the magnitude relation between the input signal and reference signal. The detail will be described later.

The high-side drive 122 and low-side drive 124 are each a photocoupler inserted for physically isolating the control signal generation circuit 108 and switching transistors Q1, Q2. When a control signal assumes a high level, the switching transistor Q1 is turned ON through the high-side drive 122. At this time, the inverter 112 inverts the control signal, so that the switching transistor Q2 is turned OFF. When a control signal assumes a low level, the switching transistor Q1 is turned OFF. At this time, the inverter 112 inverts the low-level control signal, so that the switching transistor Q2 is turned ON. Thus, the switching transistors Q1 and Q2 are turned conductive/non-conductive in a complementary manner.

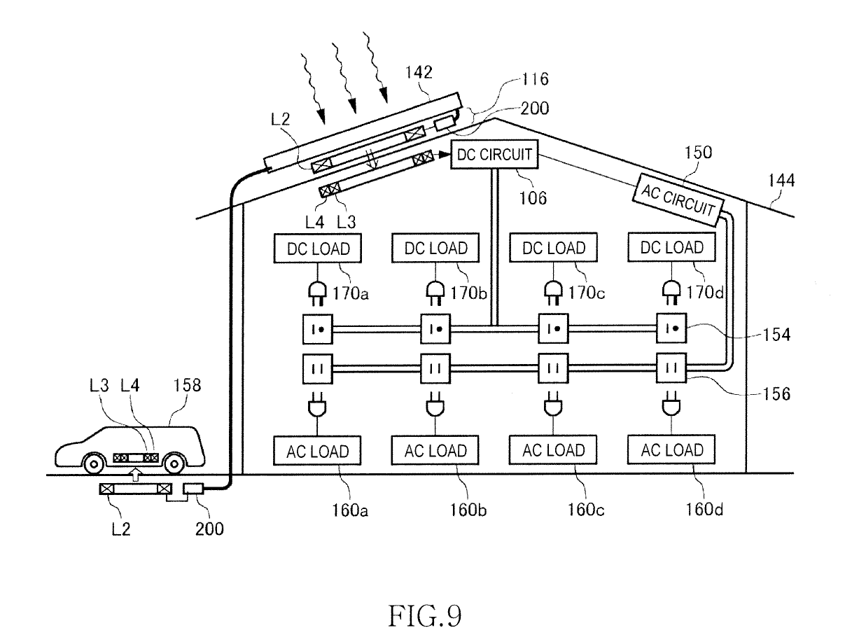

The DC power supply voltage of VA+VB of the DC circuit 106 may be supplied without modification to the DC load 170 (corresponding to a load LE in FIG. 3). Alternatively, the DC power supply voltage of VA+VB may be supplied to the DC load 170 after being level-converted by the DC-DC converter 152 as described above. The DC power supply voltage may be supplied to the DC load 170 through a DC connector 154 (DC outlet) as described later using FIG. 9.

The AC output voltage V5 is supplied to the AC load 160 (load LD). That is, the AC power (second AC power) is drawn between the points D and J. The AC voltage V5 may be supplied to the AC load 160 through an AC connector 156 (AC outlet) as described later using FIG. 9.

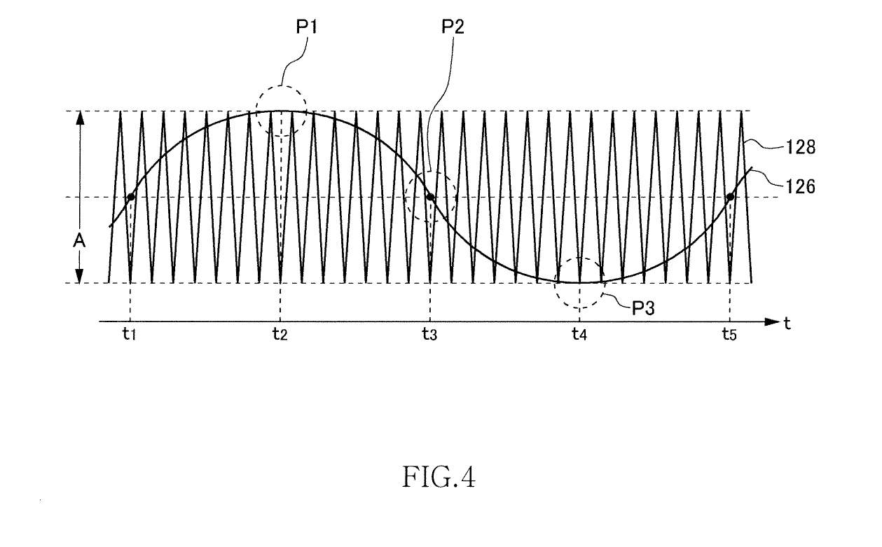

FIG. 4 is a time chart illustrating a relationship between the input signal and reference signal. A time period from time t1 to time t5 corresponds to one cycle of the input signal 126. The input signal 126 in the present embodiment is a sine-wave AC signal at a signal frequency of 50 Hz, so that one cycle corresponds to 20 msec. The reference signal 128 is a triangle-wave AC signal at a reference frequency of 20 kHz, so that one cycle corresponds to 50 μsec. In FIG. 4, for descriptive purpose, the period of the reference signal 128 is increased in some degree. The amplitude of the reference signal 128 is preferably not less than the amplitude of the input signal 126. In the present embodiment, the amplitude of the input signal 126 and that of the reference signal 128 are equal to each other. The input signal 126 and reference signal 128 each have only a positive component.

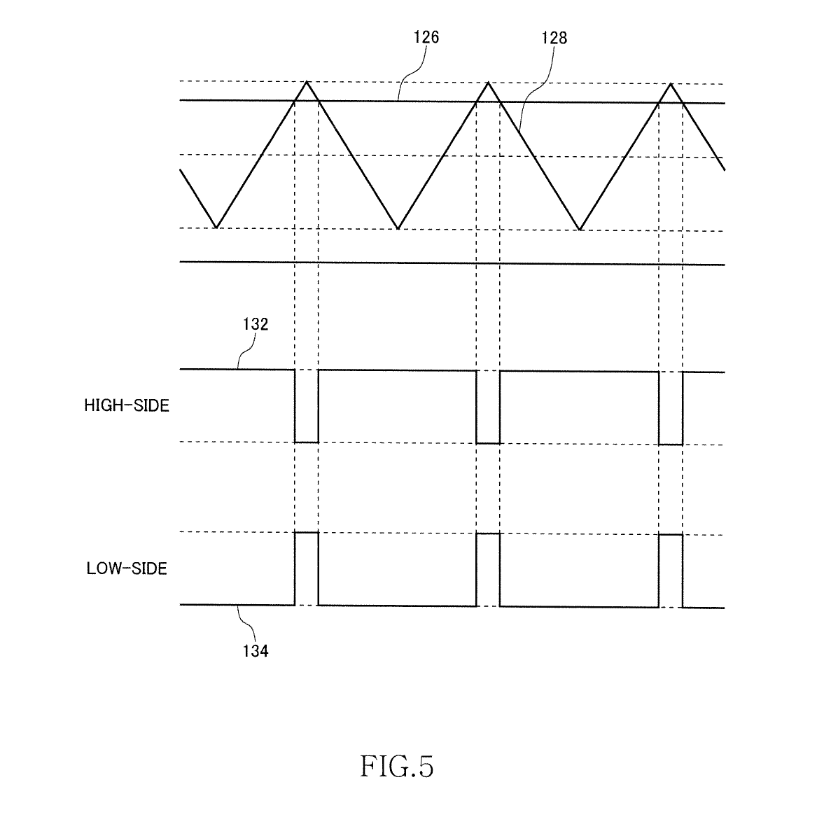

The control signal generation circuit 108 compares the above input signal 126 and reference signal 128 to change the duty ratio of the control signal according to need. Hereinafter, with reference to FIGS. 5 to 7, a description will be made of a relationship among the input signal 126, reference signal 128, and control signal in each of a high range P1 where the input signal 126 is near the maximum value, a middle range P2 where the input signal 126 is near the intermediate value, and a low range P3 where the input signal 126 is near the minimum value.

FIG. 5 is a time chart illustrating a relationship among the input signal, reference signal, and control signal in the high range P1. FIG. 5 is a time chart obtained by enlarging the vicinity of the high range P1 of FIG. 4 in the time direction. Since the signal level of the input signal 126 is high in the high range P1, the signal level of the input signal 126 is higher than that of the reference signal 128 for most of the period of time. The control signal generation circuit 108 compares the input signal 126 and reference signal 128. Then, when the input signal 126 is higher than the reference signal 128 (input signal 126>reference signal 128), the control signal generation circuit 108 outputs a high-level control signal. When the input signal is not higher than the reference signal 128 (input signal 126≦reference signal 128), the control signal generation circuit 108 outputs a low-level control signal. The output control signal is supplied to the gate of the switching transistor Q1 as a high-side control signal 132. At the same time, the output control signal is inverted by the inverter 112 to be supplied to the switching transistor Q2 as a low-side control signal 134.

The duty ratio of the high-side control signal 132 becomes 50% or more and the duty ratio of the low-side control signal 134 becomes less than 50%, so that the period in which the switching transistor Q1 is ON is longer than the period in which the switching transistor Q2 is ON. The current IS controlled by the high-side control signal 132 and low-side control signal 134 is integrated by the inductor L5 and capacitor C5 to be averaged. As a result, the current IS at the load LD flows more easily in the positive direction, and output voltage V5 assumes a positive value.

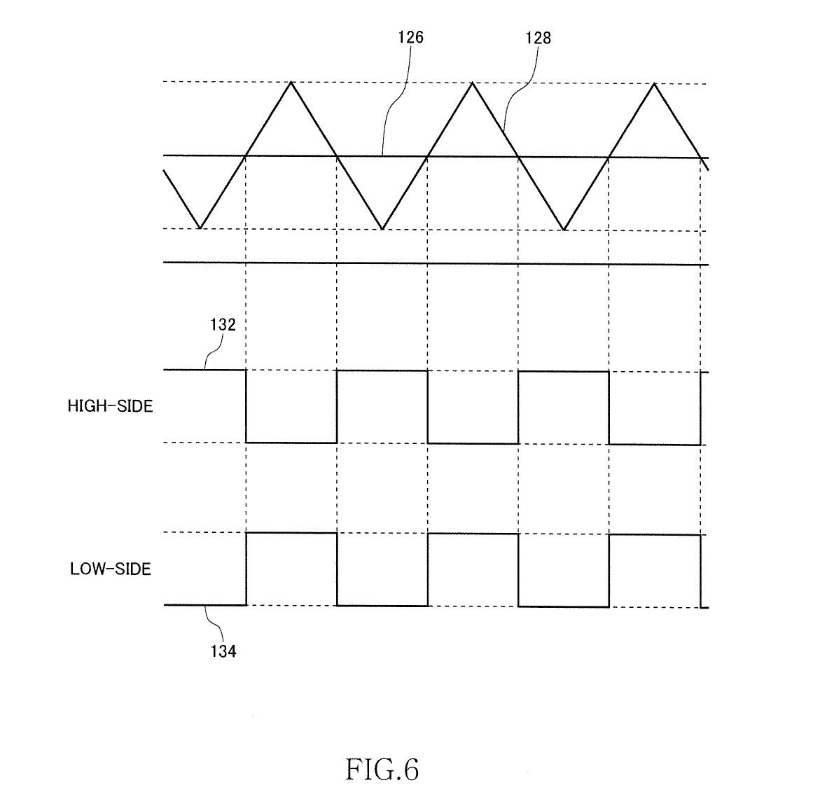

FIG. 6 is a time chart illustrating a relationship among the input signal, reference signal, and control signal in the middle range P2. FIG. 6 is a time chart obtained by enlarging the vicinity of the middle range P2 of FIG. 4 in the time direction. In the middle range P2, the signal level of the input signal 126 assumes the intermediate level of the reference signal 128. The duty ratio of the high-side control signal 132 becomes near 50% and the duty ratio of the low-side control signal 134 also becomes near 50%, so that the period in which the switching transistor Q1 is ON and period in which the switching transistor Q2 is ON balance each other. As a result, the output voltage V5 of the load LD is near zero.

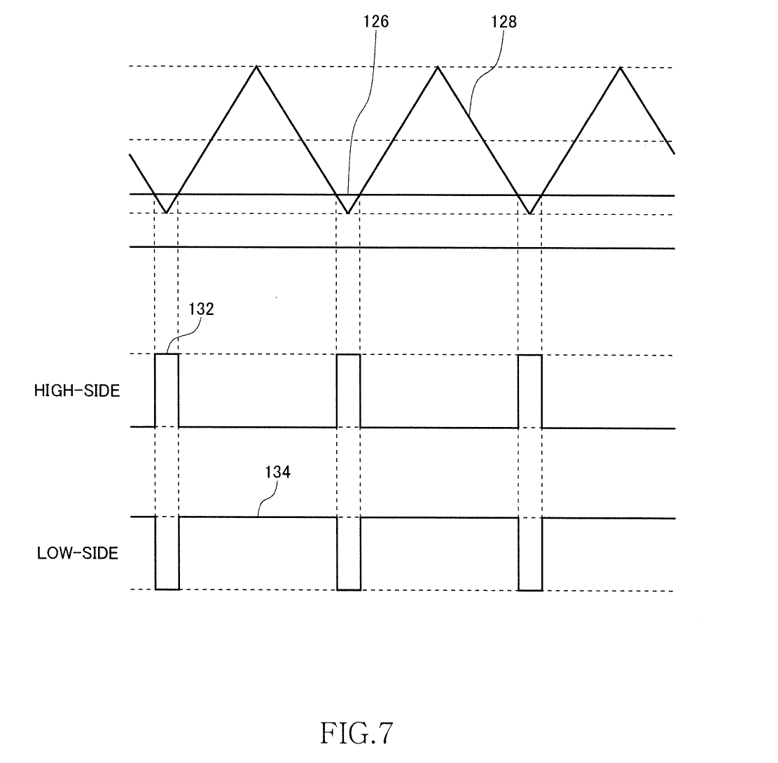

FIG. 7 is a time chart illustrating a relationship among the input signal, reference signal, and control signal in the low range P3. FIG. 7 is a view obtained by enlarging a portion around the low range P3 of FIG. 4 in the time direction. The level of the input signal 126 is low in the low range P3, so that the level of the input signal 126 is lower than that of the reference signal 128 for most of the time period.

The duty ratio of the high-side control signal 132 becomes 50% or less and the duty ratio of the low-side control signal 134 becomes 50% or more, so that the period in which the switching transistor Q1 is ON is shorter than the period in which the switching transistor Q2 is ON. As a result, the current IS at the load LD flows more easily in the negative direction, and output voltage V5 assumes a negative value.

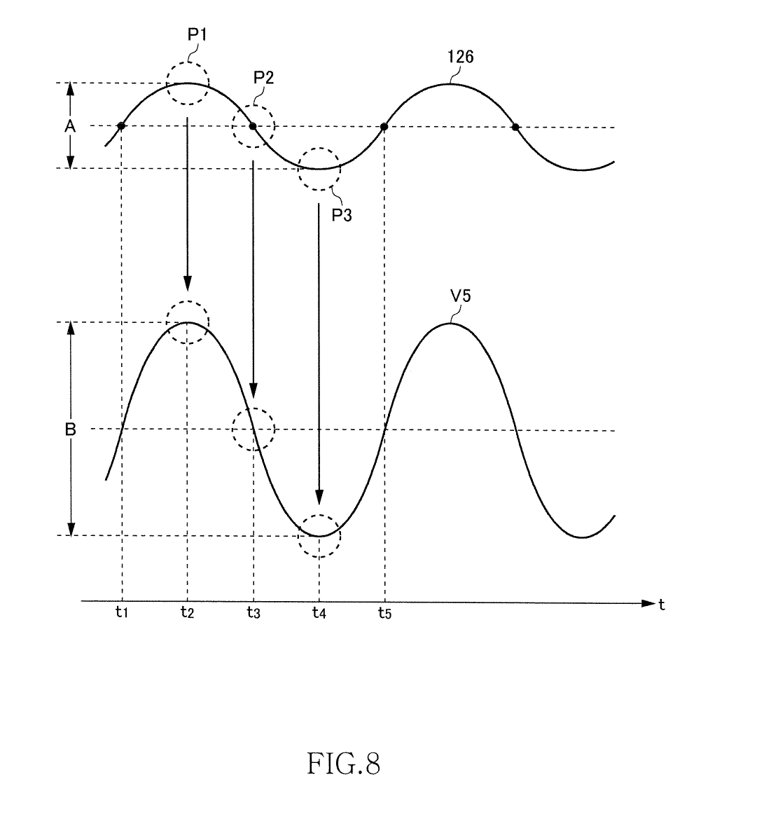

FIG. 8 is a time chart illustrating a relationship between the input signal 126 and output voltage V5. The output voltage V5 has a voltage waveform obtained by amplifying the input signal 126. The signal level of the input signal 126 is periodically measured comparing with the reference signal 128, the duty ratio of the control signal is made to appropriately change in accordance with the measurement result, and the voltage level of the output voltage V5 is controlled based on the change in the duty ratio. When an amplitude B of the output voltage V5 is set to 141 (V), AC voltage having a commercial frequency of 50 Hz and an effective value of 100 (V) can be generated at the wireless power receiver 118 side. Thus, even when AC power near the resonance frequency fr1=100 kHz is received by the receiving coil L3, output voltage V5 available as a commercial power supply can be generated.

A frequency of the AC power to be supplied to the AC load 160 need not be a commercial frequency. Controlling the frequency of the input signal allows generation of an arbitrary frequency. Thus, an electric product corresponding to the AC load 160 need not be designed on the premise of receiving the AC power at the commercial frequency.

FIG. 9 is a conceptual view illustrating a case where the wireless power transmission system 100 is applied to a standard house. The wireless power feeder 116 including the feeding coil L2, power transmission control circuit 200, and the like is installed on the upper surface of a roof 144, and a solar cell 142 is installed on the wireless power feeder 116. The solar cell 142 functions as the DC power supply 206. Some of DC power generated by the solar cell 142 is converted into AC power of the resonance frequency fr1 by another power transmission control circuit 200 buried in the ground and is fed by wireless from the feeding coil L2 in the ground to the receiving coil L3 of an EV 158. A lithium-ion cell or the like (not illustrated) incorporated in the EV 158 is charged by the wireless power feeding.

The remaining DC power generated by the solar cell 142 is fed by wireless as the AC power from the feeding coil L2 on the roof 144 to the indoor receiving coil L3. The AC power received by the indoor receiving coil L3 is converted into DC power by the DC circuit 106 and then converted into AC power of the commercial frequency by the AC circuit 150.

The DC power generated by the DC circuit 106 is supplied to DC loads 170a to 170d through the indoor DC connector 154. The AC power generated by the AC circuit 150 is supplied to AC loads 160a to 160d through the AC connector 156 of a conventional type. The DC connector 154 or AC connector 156 may be installed on a wall surface of the house.

Although common home appliances are designed on the premise of receiving AC power of the commercial frequency, most of them are actually DC power driven. Therefore, an external or incorporated AC-DC converter is often used to convert the AC power into DC power. On the other hand, in the present embodiment, the DC power generated by the DC circuit 106 can be supplied without modification to the DC loads 170a to 170d, and therefore, conversion loss can be suppressed. Further, power generated by the solar cell 142 can be supplied indoors by wireless, substantially eliminating the need for electrical wiring work. Simply installing the solar cell 142 on the roof 144 and connecting it to the wireless power feeder 116 on the roof 144 achieves electrical connection between the solar cell 142 and indoor wireless power receiver 118.

### Second Embodiment

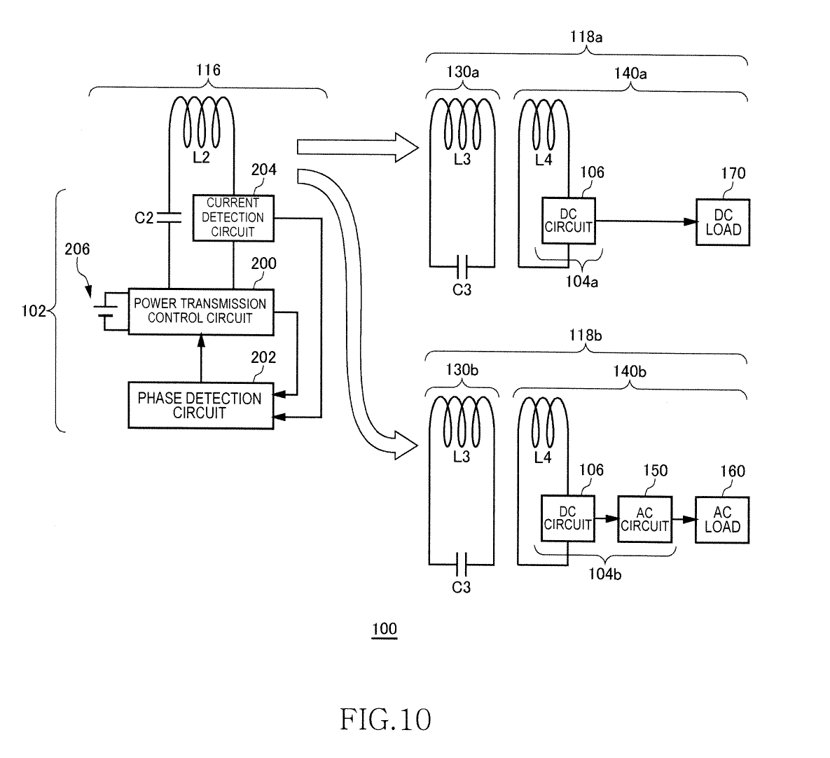

FIG. 10 is a schematic view of the wireless power transmission system 100 in a second embodiment. In the wireless power transmission system 100 in the second embodiment, a plurality of wireless power receivers 118a and 118b are related to the single wireless power feeder 116. The wireless power receiver 118a is so called a “DC type” wireless power receiver 118 that converts AC power into DC power by means of the DC circuit 106 and supplies the DC load 170 with the DC power. The wireless power receiver 118b is so called an “AC type” wireless power receiver 118 that supplies the AC load 160 with AC power generated by means of the DC circuit 106 and AC circuit 150. Power may be fed to the AC load 160 and DC load 170 simultaneously or selectively by the combination use of the DC type wireless power receiver 118a and AC type wireless power receiver 118b.

### Third Embodiment

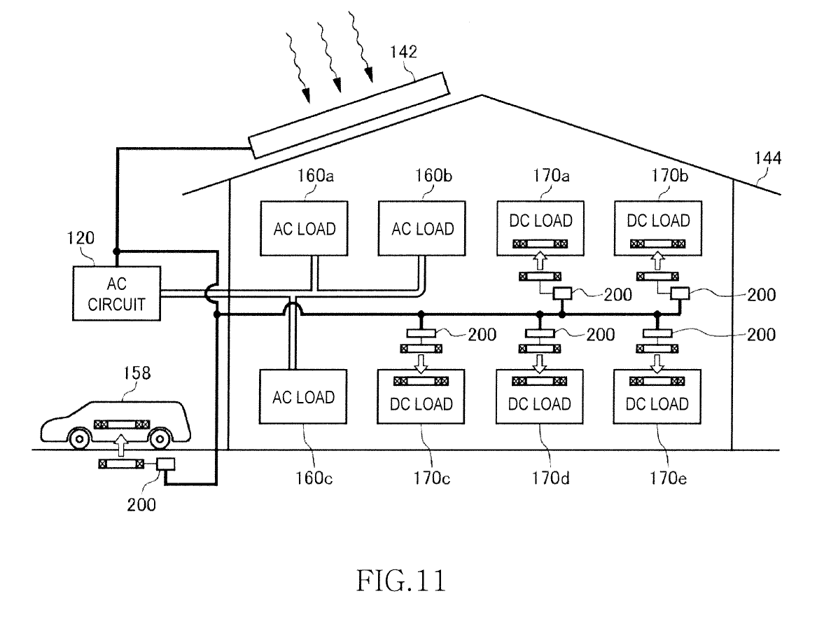

FIG. 11 illustrates an application example of the wireless power transmission system 100 in a third embodiment. Some of the DC power generated by the solar cell 142 is supplied to the EV 158 through the same path as illustrated in FIG. 9. Some of DC power is once drawn indoors by wire and then supplied to the DC loads 170a to 170e by wireless power feeding. In the third embodiment, a pair of the wireless power feeder 116 and wireless power receiver 118 is provided for each of the DC loads 170a to 170e. Further, some of the DC power generated by the solar cell 142 is converted into AC power of a predetermined frequency by the AC circuit 120. The AC circuit 120 is a common DC-AC converter. The AC power generated by the AC circuit 120 is supplied to the AC loads 160a to 160c through indoor wirings.

In the third embodiment, the DC power and AC power are generated from the solar cell 142 (DC power supply 206) and are simultaneously supplied to the indoor wirings. As described above, the DC power and AC power may be supplied simultaneously through separate channels directly from the power supply, unlike the first and second embodiments in which the DC power and AC power are separated at the wireless power receiver 118 side.

### Fourth Embodiment

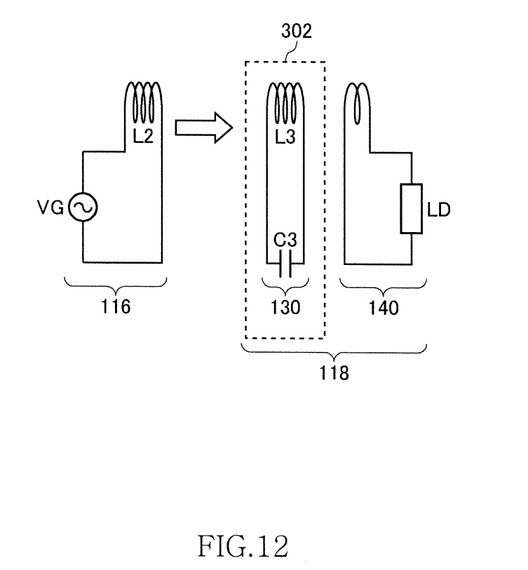

FIG. 12 is a view illustrating operation principle of the wireless power transmission system 100 according to a fourth embodiment. The wireless power transmission system 100 according to the fourth embodiment includes the wireless power feeder 116 and wireless power receiver 118. However, although the wireless power receiver 118 includes the power receiving LC resonance circuit 302, the wireless power feeder 116 does not include the power feeding LC resonance circuit 300. That is, the power feeding coil L2 does not constitute a part of the LC resonance circuit. More specifically, the power feeding coil L2 does not form any resonance circuit with other circuit elements included in the wireless power feeder 116. No capacitor is connected in series or in parallel to the power feeding coil L2. Thus, the power feeding coil L2 does not resonate in a frequency at which power transmission is performed.

The power feeding source VG supplies AC current of the resonance frequency fr1 to the power feeding coil L2. The power feeding coil L2 does not resonate but generates an AC magnetic field of the resonance frequency fr1. The power receiving LC resonance circuit 302 resonates by receiving the AC magnetic field. As a result, large AC current flows in the power receiving LC resonance circuit 302. Studies conducted by the present inventor have revealed that formation of the LC resonance circuit is not essential in the wireless power feeder 116. The feeding coil L2 does not constitute the power feeding LC resonance circuit, so that the wireless power feeder 116 does not enter the resonance state at the resonance frequency fr1. It has been generally believed that, in the wireless power feeding of a magnetic field resonance type, making resonance circuits which are formed on both the power feeding side and power receiving side resonate at the same resonance frequency fr1 (=fr0) allows power feeding of large power. However, it is found that even in the case where the wireless power feeder 116 does not contain the power feeding LC resonance circuit 300, if the wireless power receiver 118 includes the power receiving LC resonance circuit 302, the wireless power feeding of a magnetic field resonance type can be achieved.

Even when the power feeding coil L2 and power receiving coil L3 are magnetic-field-coupled to each other, a new resonance circuit (new resonance circuit formed by coupling of resonance circuits) is not formed due to absence of the capacitor C2. In this case, the stronger the magnetic field coupling between the power feeding coil L2 and power receiving coil L3, the greater the influence exerted on the resonance frequency of the power receiving LC resonance circuit 302. By supplying AC current of this resonance frequency, that is, a frequency near the resonance frequency fr1 to the power feeding coil L2, the wireless power feeding of a magnetic field resonance type can be achieved. In this configuration, the capacitor C2 need not be provided, which is advantageous in terms of size and cost.

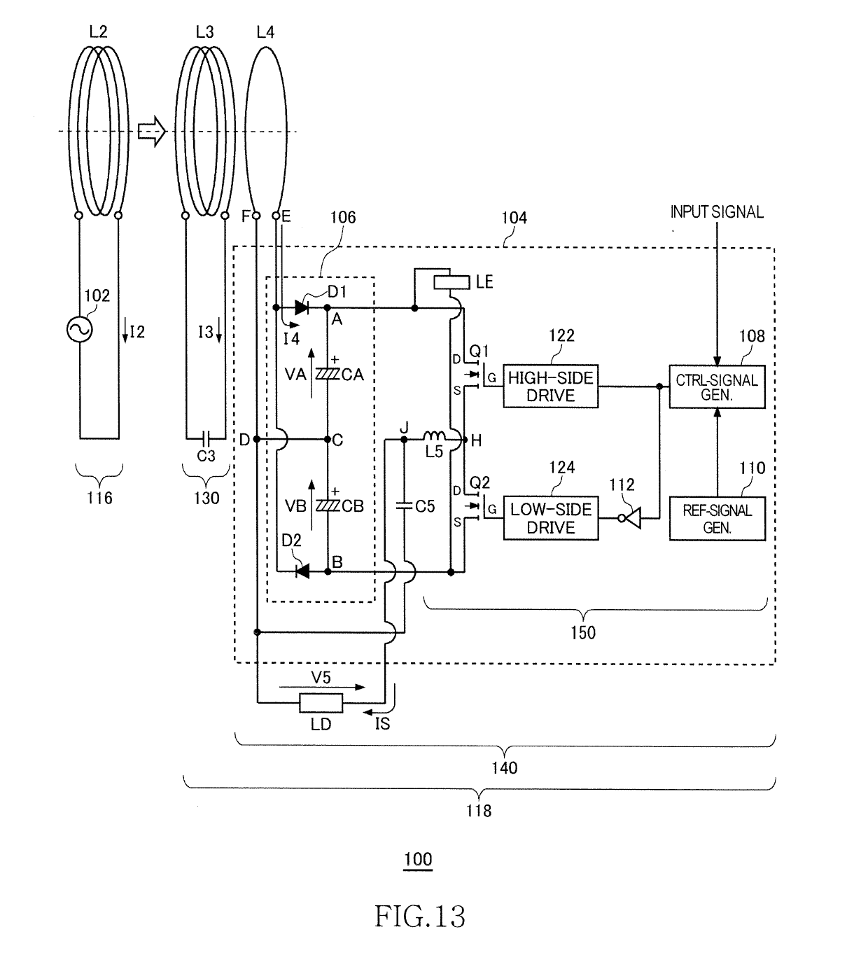

FIG. 13 is a system configuration view of the wireless power transmission system 100 according to the fourth embodiment. In the wireless power transmission system 100 of the fourth embodiment, the capacitor C2 is omitted. Other points are the same as the first embodiment.

In the configurations illustrated in FIGS. 9 to 11, the capacitor C2 can be omitted as in the fourth embodiment.

Finally, concrete application examples of the wireless power transmission system 100 according to the above embodiments will be described.

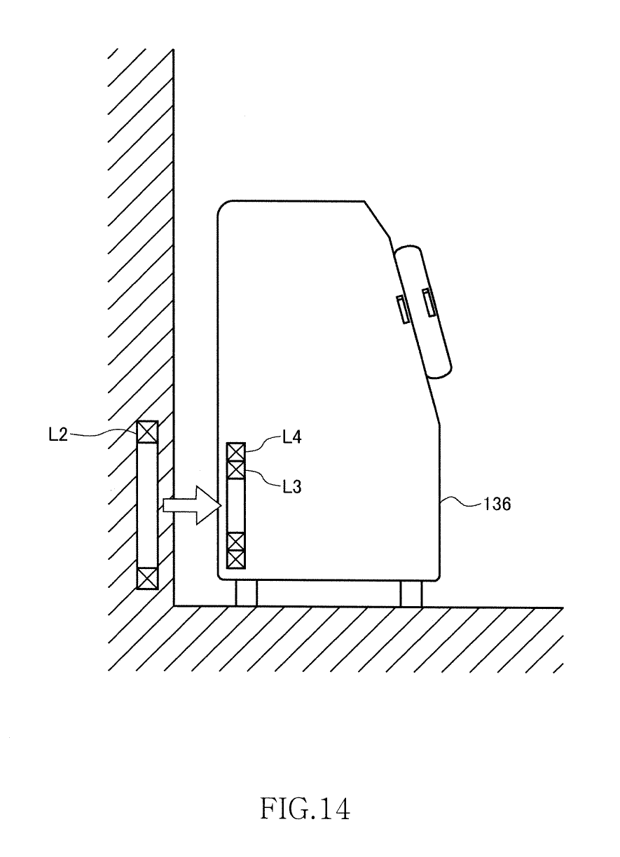

FIG. 14 is a view illustrating a wireless-enabled drum-type washing machine 136. The feeding coil L2 is buried in a wall surface of the house, and the receiving coil L3 and loading coil L4 are incorporated in the drum-type washing machine 136. With this configuration, simply installing the drum-type washing machine 136 at a position at which the receiving coil L3 faces the feeding coil L2 allows the drum-type washing machine 136 to receive power and eliminates the need for wirings for power feeding. The same can be achieved in the case of other home appliances such as a refrigerator and a television.

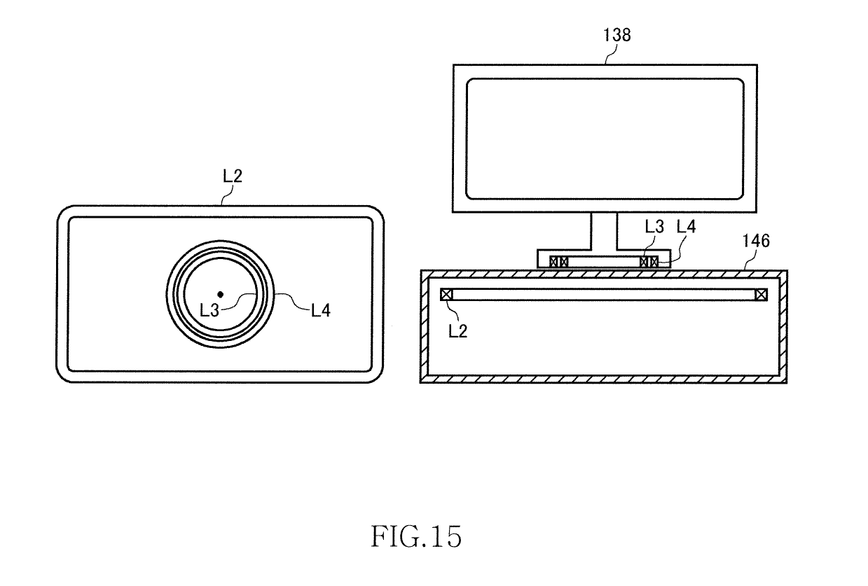

FIG. 15 is a view illustrating a television 138 and a television table 146 which are wireless-enabled. The right side of FIG. 15 illustrates the television 138 as viewed from front, and the left side thereof illustrates the television 138 as viewed from above. The television table 146 incorporates the feeding coil L2, and television 138 incorporates the receiving coil L3 and loading coil L4. With this configuration, simply installing the television 138 at a position at which the receiving coil L3 faces the feeding coil L2 allows the television 138 to receive power. The same can be achieved in the case of other home appliances such as a tabletop electric fan and a mobile device.

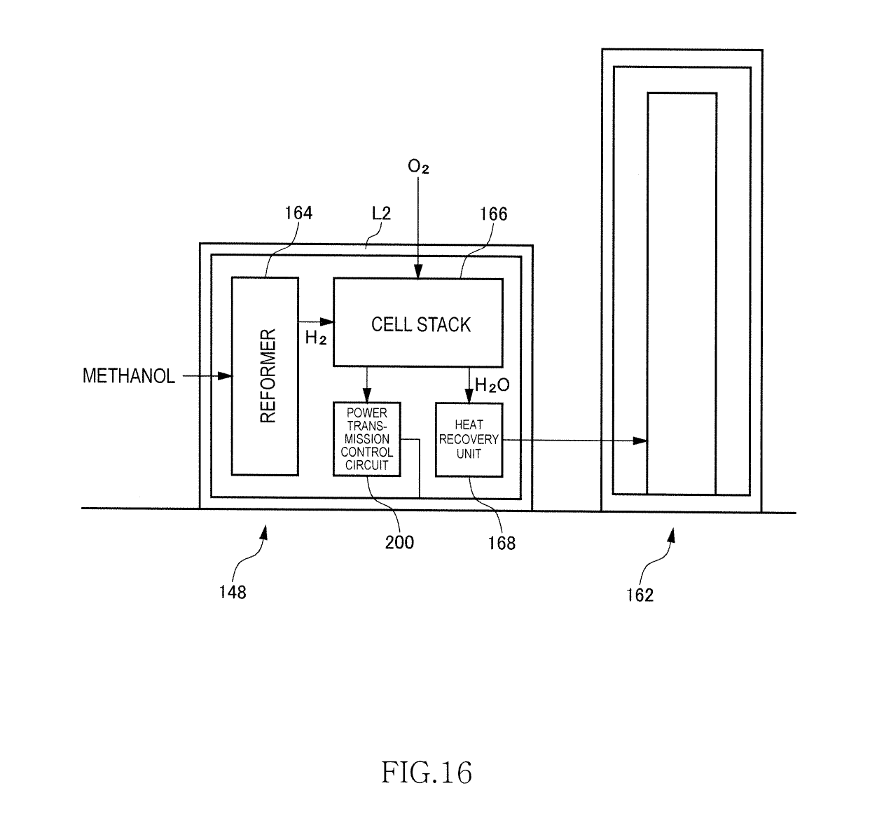

FIG. 16 is a view illustrating a wireless-enabled fuel cell 148. The fuel cell 148 includes a reformer 164, a cell stack 166, the power transmission control circuit 200, a heat recovery unit 168, and the feeding coil L2. In other words, the fuel cell 148 incorporates the wireless feeding device 116. The reformer 164 extracts hydrogen from methanol contained in city gas and supplies the cell stack 166 with it. The cell stack 166 serves as the DC power supply 206 that generates electricity by a chemical reaction between the hydrogen supplied from the reformer 164 and oxygen taken in from the air.

The DC power generated by the cell stack 166 is converted into AC power of the drive frequency fr1 by the power transmission control circuit 200 and fed by wireless to the receiving coil L3 (not illustrated in FIG. 16) through the feeding coil L2.

Water and heat generated by the chemical reaction between the hydrogen and oxygen are recovered by the heat recovery unit 168 as hot water, and the hot water is stored in a tank 162. This hot water is used as household water.

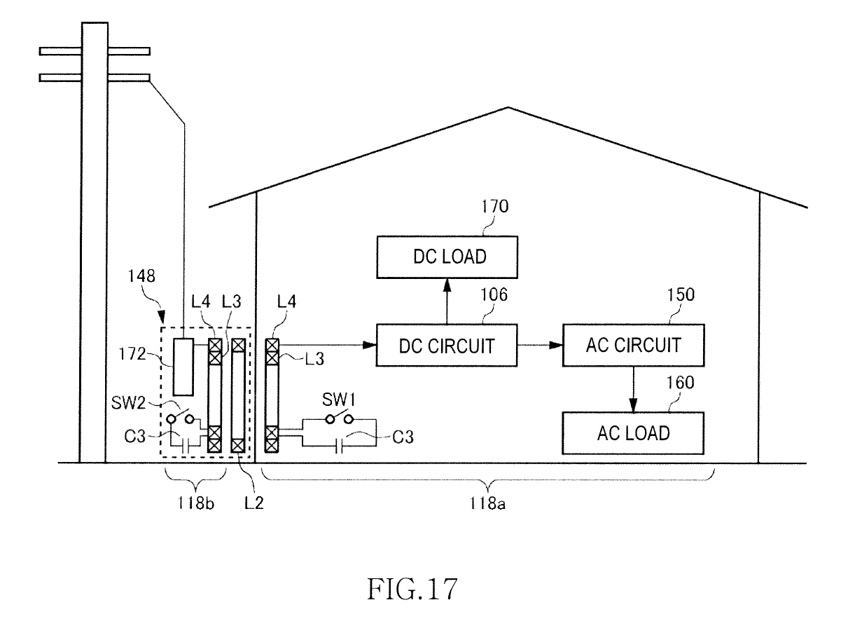

FIG. 17 is a view illustrating an application example of the wireless power transmission system 100 including the fuel cell 148. The fuel cell 148 illustrated in FIG. 17 includes not only the wireless power feeder 116 but also the wireless power receiver 118b. Power generated by the fuel cell 148 is supplied to the indoor wireless power receiver 118a. When a switch SW1 which is connected to the receiving coil L3 is turned OFF, power feeding to the wireless power receiver 118a is stopped. Some of the power from the fuel cell 148 is also supplied to the wireless power receiver 118b. The power feeding to the wireless power receiver 118b is controlled by a switch SW2. The power received by the wireless power receiver 118b is supplied to a power grid through a power conditioner 172. Thus, surplus power of the fuel cell 148 can be sold.

The wireless power transmission system 100 has been described based on the embodiments. According to the wireless power transmission system 100, the output voltage V5 of the load LD can be controlled based on a waveform of an input signal to be supplied to the power receiving side. Thus, even when the power feeding side adjusts the drive frequency of the AC power supply 102 so as to achieve a maximum power efficiency, the receiving side can stably generate a desired output voltage V5 from received power.

Adoption of the wireless power feeding can eliminate the need for a wiring from outdoor to indoor (see FIG. 9, FIG. 17, and the like), so that simply installing the solar cell 142 or fuel cell 148 outdoors allows the indoor wireless power receiver 118 and these power supplies to be connected to each other. The wireless power transmission system 100 can support the DC power supply 206 such as the solar cell 142 or fuel cell 148, AC load 160, and DC load 170.

The present invention has been described based on the above embodiments. It should be understood by those skilled in the art that the above embodiments are merely exemplary of the invention, various modifications and changes may be made within the scope of the claims of the present invention, and all such variations may be included within the scope of the claims of the present invention. Thus, the descriptions and drawings in this specification should be considered as not restrictive but illustrative.

The reference signal generated by the reference signal generation circuit 110 may be an AC signal having not only a triangle wave but also a saw-tooth waveform, a sine wave, or a rectangular wave. Although the duty ratio of the control signal represents the signal level of an input signal in the above embodiments, the signal level of an input signal may be represented by the amplitude or frequency of the control signal. Further, the process in which received power is converted into DC voltage by the DC circuit 106 is not essential. For example, the received AC power may be controlled by the control signal so as to control the output voltage V5.

The “AC power” used in the wireless power transmission system 100 may be transmitted not only as an energy but also as a signal. Even in the case where an analog signal or digital signal is fed by wireless, the wireless power transmission method of the present invention may be applied.

Although the “magnetic field resonance type” that utilizes a magnetic field resonance phenomenon has been described in the present embodiments, the magnetic field resonance is not essential in the present invention. For example, the present embodiment can be applied to the above-described type A (for short distance) that utilizes the electromagnetic induction, wherein the feeding coil and receiving coil are electromagnetically coupled as in the “magnetic field resonance type”.

What is claimed is:

1. A wireless power receiver that receives, at a receiving coil, AC power fed from a feeding coil by wireless based on a magnetic field coupling between the feeding coil and a receiving coil, the receiver comprising:
the receiving coil; and
an adjustment circuit that receives a first AC power received by the receiving coil, wherein
the adjustment circuit including: a first conversion circuit that converts the first AC power into DC power; and a second conversion circuit that converts the DC power into a second AC power of a predetermined frequency,
the adjustment circuit outputting the DC power and second AC power through separate channels.

2. The wireless power receiver according to claim 1, further comprising a loading coil magnetically coupled to the receiving coil to receive the first AC power from the receiving coil, and wherein
the adjustment circuit receives the first AC power through the loading coil.

3. The wireless power receiver according to claim 1, wherein
the DC power output from the first conversion circuit is supplied to a DC connector installed in a wall surface of a house, and
the second AC power output from the second conversion circuit is supplied to an AC connector installed in the wall surface of the house.

4. The wireless power receiver according to claim 1, wherein
the second conversion circuit further includes:
a reference signal generation circuit that generates a reference signal at a reference frequency; and
a control signal generation circuit that receives an input signal including a frequency component lower than the reference frequency and generates a control signal representing a magnitude relation between a signal level of the reference signal and that of the input signal, and
the second conversion circuit generates the second AC power from the DC power according to the control signal.

5. The wireless power receiver according to claim 4, wherein
the control signal generation circuit changes a duty ratio of the control signal according to the magnitude relation between the signal level of the reference signal and that of the input signal.

6. A wireless power transmission system comprising:
the wireless power receiver as claimed in claim 1;
the feeding coil; and
a power transmission control circuit that supplies the feeding coil with AC power to make the feeding coil feed the AC power to the receiving coil.

7. The wireless power transmission system according to claim 6, wherein
the feeding coil is installed outdoors, and the receiving coil is installed indoors.

8. A wireless power transmission system for feeding power by wireless from a feeding coil to a receiving coil based on a magnetic field coupling between the feeding coil and receiving coil, the system comprising:
the feeding coil;
a plurality of the receiving coils;
a power transmission control circuit that supplies AC power to the feeding coil to make the feeding coil feed the AC power to the receiving coils;
a first conversion circuit that converts a first AC power received by each receiving coil into DC power; and
a second conversion circuit that converts the DC power into a second AC power of a predetermined frequency,
the receiving coils including a first receiving coil that outputs the DC power through the first conversion circuit and a second receiving coil that outputs the second AC power through both the first and second conversion circuits.
